(19) United States
(12) Patent Application Publication
(10) Pub. No.: US 2023/0176388 A1
(43) Pub. Date: Jun. 8, 2023

(54) ON-AXIS HOLOGRAPHIC SIGHT

(71) Applicant: Marsupial Holdings, Inc., Waitsfield, VT (US)

(72) Inventors: William P Parker, Waitsfield, VT (US); Julie Parker, Waitsfield, VT (US)

(21) Appl. No.: 17/997,542

(22) PCT Filed: Apr. 30, 2021
(86) PCT No.: PCT/US21/30314

§ 371 Date: Oct. 29, 2022

Related U.S. Application Data
(60) Provisional application No. 62/704,716, filed on May 25, 2020.
(60) Provisional application No. 62/704,240, filed on Apr. 29, 2020.

(51) Int. Cl. G02B 27/01; F21V 8/00; G02B 27/30

(52) U.S. Cl. CPC G02B 27/0189; G02B 27/0101; G02B 27/0179; G02B 6/0026; G02B 27/30; F41G 1/30

(57) ABSTRACT

A sight or aiming device is provided that can be attached to a firearm or other device with minimal visual and weight impacts and includes a light source, a pattern producing element, and an imageguide optical combiner. The user may have access to mechanical adjustments to “zero” the sight to the barrel of the instrument and to correct an aim point for windage and elevation. The orientation and construction of the sight facilitates use with a holster. The sight has an on-axis (or in-line) optical design, and thus the illumination of a reticle by the light source and its path entering the on-axis imageguide holographic combiner is approximately parallel to the boresight of the instrument that the sight is attached to.

### FIELD OF THE INVENTION

The present invention generally relates to aiming devices. In particular, the present invention is directed to an on-axis holographic sight.

### BACKGROUND

There are several types of optical sights that enable a user of an instrument to visually align the instrument. In the case of a weapon, for example, such as a pistol, rifle, shotgun, handgun and semi-automatic weapon, to aim the weapon more accurately. Examples of such optical aiming and sighting devices include aiming lasers, telescopic sights, spotting scopes, reflection “reflex” or “red dot” sights, and sights which incorporate holographic images of various one and two-dimensional reticle patterns (“holographic sights”). Holographic sights have used a see-through refection holographic optical element (HOE) as an image combiner which allows a user to look through the HOE at a targeted object and view a spot of light or an image of a holographically reconstructed reticle. FIG. 1 schematically illustrates the primary components and optical ray paths for an example of such a prior art device according to U.S. Pat. No. 6,490,060. A light source 10, typically a laser diode, projects a diverging beam of light 14 which is reflected by a mirror 18, creating a first reflected expanding beam 22. The reflected beam 22 in this example is also diverging. Beam 22 travels to mirror 26, which collimates the beam and directs it to a diffraction grating 30, which has an angle specific response to the laser wavelength and directs the laser light to the HOE 34, which projects an image of a one-dimensional spot or a two-dimensional reticle pattern. An individual's eye can view the image of the laser dot or a reticle and overlayed on a target (not shown) through the largely transparent HOE 34.

Other sights include reflective red-dot sights that have a display substrate for mounting on a device and an optics module that includes an LED or in some embodiments a computer-generated imagery system and optical elements for generating an aiming “red dot” or more complicated images and projecting the images on the display substrate. FIG. 2 schematically illustrates the primary components and optical ray paths for an example of such a prior art device according to U.S. Pat. No. 8,166,698. A reflex sight 50 is mountable on a weapon and includes a display screen (image combiner) 52 mounted on an optics module 56 contained in a housing 58. Optics module 56 has an imagery generating system 60 and optical elements for generating images and projecting a beam 62 of the images on display screen (image combiner) 52.

These types of sighting devices have several disadvantages. Although attempts at athermalization of the beam path in holographic sights have been made using a diffraction grating with temperature related optical dispersion opposite to that of the HOE, the use of a diverging laser light to off-axis illuminate (or obliquely illuminate) the HOE can cause temperature-induced drift of the illumination path and an unacceptable angular error in the position of the reconstructed reticle in the target plane as the housing and optical element temperatures change. Also, the wavelength of light produced by typical laser diodes depends on a number of factors, including the temperature of the laser diode. For example, some laser diodes exhibit a shift in output wavelength of approximately 0.30 nm/° C. The change in temperature of the laser diode may be due to environmental conditions or due to heating from operation of the diode, associated circuitry, or the device the laser diode is mounted on. The angle of diffraction of a HOE or diffraction grating is wavelength dependent, and, as such, as the temperature shifts there is a resulting wavelength shift, causing the position of the reconstructed reticle to shift. Further, since the user views the target through the HOE, ambient light may cause a range of optical effects, including glare and a rainbow effect that can be distracting to the user. The HOE emulsion or the supporting and mounting elements may have defects that are detectable to the eye and thus distracting to the user. Moreover, certain types of HOEs are produced from holographic recording materials such as silver halide emulsions which are affected by light and moisture and can become hazy, deteriorate or darken over time. Also, these designs can be difficult to package in a compact sight owing to the volume of the complex and highly angled optical path, as well as the relative mechanical position of the various components that must be precisely maintained or the image quality and/or image position may suffer, which will affect the precision and repeatability of aiming accuracy. Lastly, water/humidity intrusion is difficult to prevent in these designs and will degrade the quality of the output of the sight over time.

In general, reflex sights suffer from distortions of the visual field as seen by the user due to the complexity and fabrication errors of the multiple optical elements that make up the reflection sight's optical path. It is common for users of reflex sights to see optical distortions or magnification errors in the real-world view seen through the mirror of a reflex sight, including parallax which displaces the user's view of the target relative to the intended aim point, particularly at the extremes of the visual field, all of which are limiting factors in the accuracy and usefulness of the reflex sight. The on-axis holographic sight which is the subject of this invention has none of these limiting defects.

### SUMMARY OF THE DISCLOSURE

An on-axis holographic sight includes a base configured to engage a mounting location on an instrument, wherein the base includes an image projection system, the image projection system including a power supply, a light source, and a controlling circuitry. A light shield frame is attached to the base, a substantially transparent imageguide image combiner window contained within the frame, and an imageguide display system optically coupled to the image combiner window, the imageguide display system including a light source, an image generating element, a light coupling optical element, and an imageguide element. The light source is configured to direct light to the image generating element, the image generating element is configured to project image information to the light coupling optical element, the light coupling projection optic is configured to transmit the image information into the imageguide element, and the imageguide element is configured to direct the image information through the image combiner window such that a virtual image is viewable by a user viewing a real-world scene through the image combiner window when the sight is attached to the instrument.

Additionally or alternatively, the sight includes an eye-tracking system, wherein the eye-tracking system is in communication with the controlling circuitry.

Additionally or alternatively, the sight is connected to a plurality of sensors, and wherein the plurality of sensors includes a motion sensor, a first light sensor, and a second light sensor.

Additionally or alternatively, the image information is modulated based on light conditions determined by the first light sensor and the second light sensor.

Additionally or alternatively, the imageguide display system is activated based on movement of the instrument detected by the motion sensor.

Additionally or alternatively, the image generating element is a shadow mask.

Additionally or alternatively, the image generating element is a diffractive optical element.

Additionally or alternatively, the light source is a laser.

Additionally or alternatively, the light coupling optical element is a holographic optical element.

Additionally or alternatively, the sight further includes a lens between the light source and the light coupling optical element.

Additionally or alternatively, the light coupling optical element is an input optical element and wherein an output optical element is optically coupled to the imageguide element.

Additionally or alternatively, the image information is relayed from the image generating element to the image combiner window through a plurality of diffraction grating optical elements and total internal reflection in the imageguide element without passing through air.

Additionally or alternatively, the image information is transmitted to the user without being collimated via a concave mirror.

Additionally or alternatively, the image information includes a reticle pattern.

Additionally or alternatively, the light source is on a side of the imageguide element opposite to that of a user of the instrument viewing the image combiner window.

Additionally or alternatively, the light source is on a side of the imageguide element that is the same as that of a user of the instrument viewing the image combiner window.

Additionally or alternatively, the combiner window attenuates less than 10% of broadband ambient visible light striking the combiner window.

Additionally or alternatively, one of the plurality of holographic optical elements includes a reflective coating on a side opposite from the light engine.

Additionally or alternatively, the plurality of diffraction grating holographic optical elements multiply the holographic image in an axis perpendicular to a grating vector such that a user can see all of the virtual image in an increased eyebox in that axis.

Additionally or alternatively, the plurality of diffraction grating optical elements and imageguide element together multiply the image information along two axes such that a user can see the virtual image in an increased eyebox in those axes.

Additionally or alternatively, at least one of the plurality of diffraction grating optical elements has an outcoupling efficiency that varies in an axis of propagation of the image information such that a brightness of the virtual image is made uniform in the eyebox.

Additionally or alternatively, the imageguide display system further includes a diffraction grating holographic optical element with dual-axis expansion, the diffraction grating holographic optical element including two overlapping linear grating structures, the overlapping linear grating structures including a plurality of right slant grating lines and a plurality of left slant grating lines, wherein the plurality of right slant grating lines and the plurality of left slant grating lines form a pattern of holes or posts that are a superposition of the plurality of right slant grating lines and the plurality of left slant grating lines.

Additionally or alternatively, the plurality of right slant grating lines and the plurality of left slant grating lines run at 45 degrees and are perpendicular to each other.

Additionally or alternatively, the imageguide display system further includes a diffraction grating holographic optical element, the diffraction grating holographic optical element including a first portion and a second portion, wherein the first portion and the second portion include a diffracting structure that is equivalent to the superposition of a plurality of right slant rulings and a plurality of left slant rulings, wherein the plurality of right slant rulings and the plurality of left slant rulings run in a pattern of holes or posts, and wherein the diffraction grating holographic optical element includes a third portion separating the first portion from the second portion, wherein the third portion is unruled.

Additionally or alternatively, the imageguide display system further includes an achromatic aspheric lens configured to collimate light from the light source into a well spherically and chromatically corrected beam.

Additionally or alternatively, the imageguide display system further includes a toroidal lens configured to collimate light from the laser into a uniform beam with radially symmetric divergence.

Additionally or alternatively, the sight further includes an elevation adjustment.

Additionally or alternatively, the sight further includes a windage adjustment.

Additionally or alternatively, the controlling circuitry generates a PWM signal that controls a brightness of the light source.

Additionally or alternatively, the virtual image appears at a distance from the instrument when viewed by the user through the image combiner window.

In another aspect, a method for assisting with optical aiming of an instrument includes attaching a base to the instrument, the base including a substantially transparent display window optically coupled to an image display system, producing a light from a light source within the base, generating an image information by passing the light through an image generating element within the base, directing the image information to an input light coupling optical element that transmits the image into an internally reflecting imageguide, and displaying the image through the display window such that the virtual image is viewable to a user of the instrument. The virtual image appears to be at a distance to a user looking through the window.

In another aspect, a sighting device includes a housing configured to engage with an instrument, a light source in the housing, an image generating element in the housing configured to receive light from the light source, an input light coupling optical element in the housing configured to receive an image information from the image generating element, an imageguide optically coupled to the input light coupling optical element. The input light coupling optical element is configured to direct the image information into the imageguide, and an output light coupling optical element optically coupled to the imageguide, and the output light coupling optical element is configured to receive the image information from the imageguide and project a virtual image out of the housing such that the virtual image is viewable to a user of the instrument and appears to be at a distance from the instrument.

Additionally or alternatively, the image information is transmitted from the input light coupling optical element to the user without a concave mirror.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an optical ray schematic for a prior art holographic sighting device;

FIG. 2 is an optical ray schematic for a prior art reflex sight;

FIG. 3A is a perspective view of an on-axis holographic sight according to an embodiment of the present invention shown attached to a portion of a weapon;

FIG. 3B is a rear perspective view of an on-axis sight in accordance with an embodiment of the present invention;

FIG. 3C is a front perspective view of the on-axis sight shown in FIG. 3B;

FIG. 3D is a bottom perspective view of the on-axis sight shown in FIG. 3B;

FIG. 3E is a rear view of the on-axis sight shown in FIG. 3B;

FIG. 3F is a side view of the on-axis sight shown in FIG. 3B;

FIG. 3G is a top view of the on-axis sight shown in FIG. 3B;

FIG. 3H is a cut away side view of the on-axis sight shown in FIG. 3B;

FIG. 4 is a schematic of an imageguide display system with an on-axis holographic image combiner according to an embodiment of the present invention;

FIG. 5 is a schematic of a display projection system for generating a reticle pattern using a mask according to an embodiment of the present invention;

FIG. 6 is a schematic of another imageguide display system with an on-axis holographic image combiner according to an embodiment of the present invention;

FIGS. 7A-7B depict front and side views of a two-dimensional pupil expanding holographic optical element for use in an on-axis holographic sight according to an embodiment of the present invention along with a sideview;

FIG. 8 is a representation of a diffraction grating for use in an on-axis holographic sight according to an embodiment of the present invention;

FIG. 9 is a schematic of a three grating pupil expanding imageguide in accordance with an embodiment of another aspect of the present invention;

FIG. 10 is a schematic of components for an on-axis sight connected to sensors in accordance with another embodiment of the present invention;

FIG. 11 is an exemplary circuit diagram for implementing an aspect of an embodiment of the present invention;

FIG. 12 depicts a view through an on-axis sight showing an image displayed on a combiner window generated by an image projection system with minimum visual distortions in accordance with an embodiment of another aspect of the present invention; and

FIGS. 13A-13D illustrate different effects on image projection due to changing angle of an image guide based on the relative locations of the light source and the viewer with respect to the image guide.

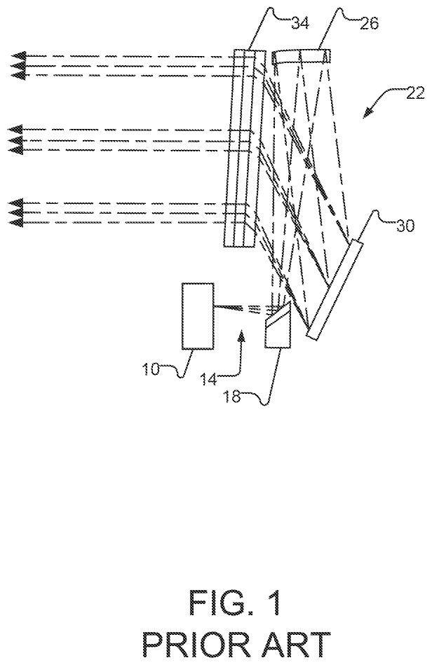

### DESCRIPTION OF THE DISCLOSURE

A sight or aiming device of the present invention can be attached to, or incorporated in, any instrument for which optical pointing is involved with minimal visual and weight impacts. Applications may include firearms, bows, telescopes, transits, sporting goods, or any other instruments that would benefit from optical pointing. The sighting devices may be useful for firearms or combat training, developing marksmanship skills, and increasing situational awareness (via augmented reality aspects). For simplicity, unless otherwise noted, the sighting devices will be discussed herein with respect to a use with a gun or firearm.

In certain embodiments, the sight can automatically adjust the brightness of the aiming dot or holographic reticle to compensate for light levels and lighting effects (at the target and for the user's ambient light conditions). In certain embodiments, the user has access to mechanical adjustments to “zero” the sight to the barrel of a weapon and to correct an aim point for windage and elevation. In certain embodiments, the orientation and construction of the sight facilitates use with a standard holster. In certain embodiments, the sight imageguide incorporates a single diffraction grating incorporating both input and output areas and that has single or dual axis expansion. Alternatively, the imageguide may have a combination of diffracting structures on opposite sides of the imageguide that provide coupling into the imageguide as well as image expansion in at least one axis. In an embodiment, the sight displays a dot of light distinguishable from the background which is located and sized to assist the user in aiming. In certain embodiments, an image of a reticle pattern is produced with a pattern generating diffractive optical element (DOE). In certain embodiments, the reticle pattern is defined using a shadow mask or aperture and a lens to focus the image of the reticle and facilitate the image injection into the imageguide. In certain embodiments, the sight's diffraction grating includes areas with a reflective coating to improve image characteristics or light throughput efficiency within the imageguide. In certain embodiments the image seen by the user is static. In certain embodiments the image seen by the user is dynamic and may be remotely adjusted, moving, refreshed, animated, sensor generated, computationally produced or modified in real time to impart to the user additional useful information. In certain embodiments, the sight incorporates a wavelength or polarization selective coating to reduce the forward projected light to minimize the light signature of the sight detectable by the target.

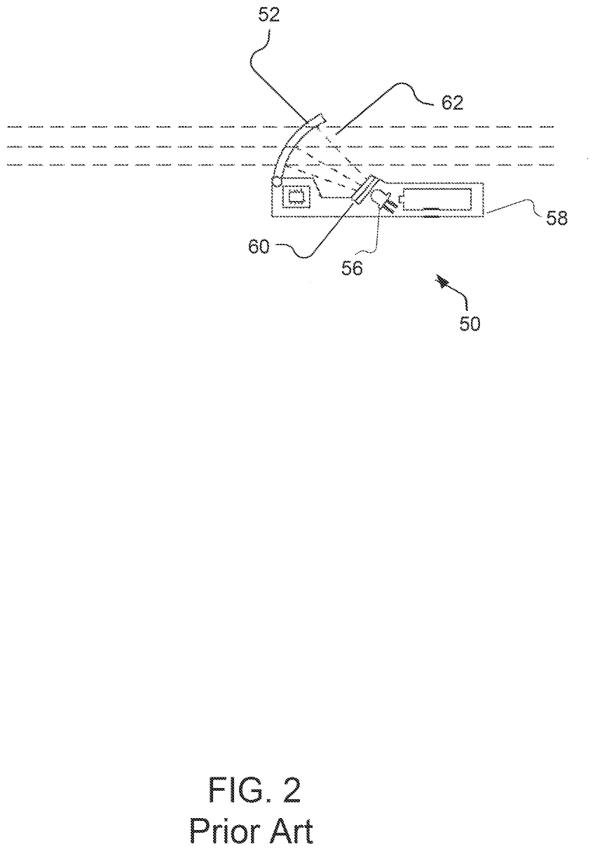

A sight described herein has an on-axis (or in-line) optical design, and thus the illumination of the reticle by the light source and its path entering the on-axis imageguide holographic combiner are approximately parallel to the boresight of the device, e.g., gun, that the sight is attached to, subject to intentional adjustments, such as for aiming and trajectory compensation. This makes the sight of the present invention less expensive to produce and less sensitive to manufacturing tolerances and temperature changes compared to prior art devices, which may have numerous optical surfaces, complicated mechanical components, a wide range of materials of construction, and steeply angled or exposed beam paths. Additionally, the entirety of the optical path for the disclosed sight is enclosed so that the surfaces in the optical path are not subject to light losses and image degrading dust, dirt or moisture, whereas the prior art reflex sight designs, such as the sights shown in FIG. 2, the light passes through open air before reflecting from the optical combiner.

Additional advantages of a sight described herein include, but are not limited to, being easily scalable for use on a wide range of platforms from bows to pistols to shotguns and rifles. Certain embodiments of the sight may be used with instruments and tools for which an aid in aiming with the provision for a patterned reticle has usefulness, and that can present visual information to the user, such as surveyor's transits, binoculars, telescopes, cameras, and construction tools. Typically, the sight will have a compact design, have a relatively light weight, have low power consumption for long battery life, and, due to its simplified configuration, have fewer parts and greatly reduced manufacturing tolerance, which also make it is less expensive to produce than many other reflex or holographic sights.

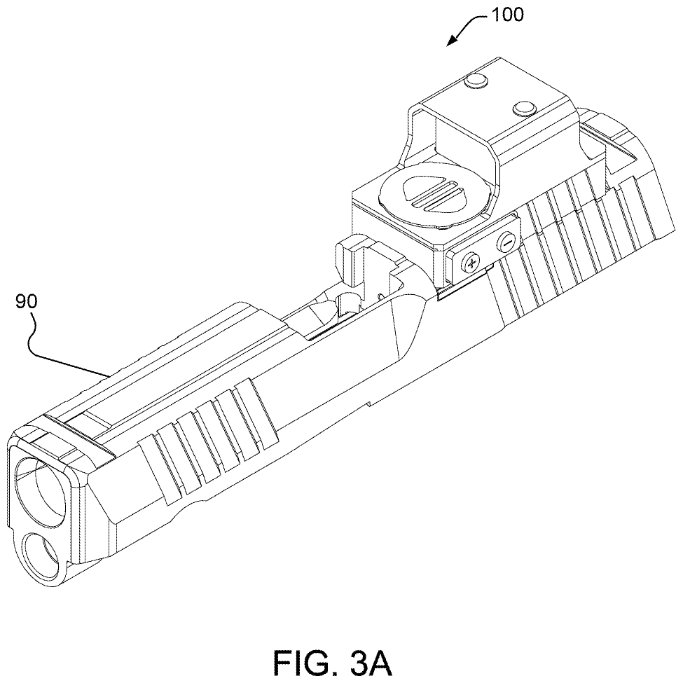

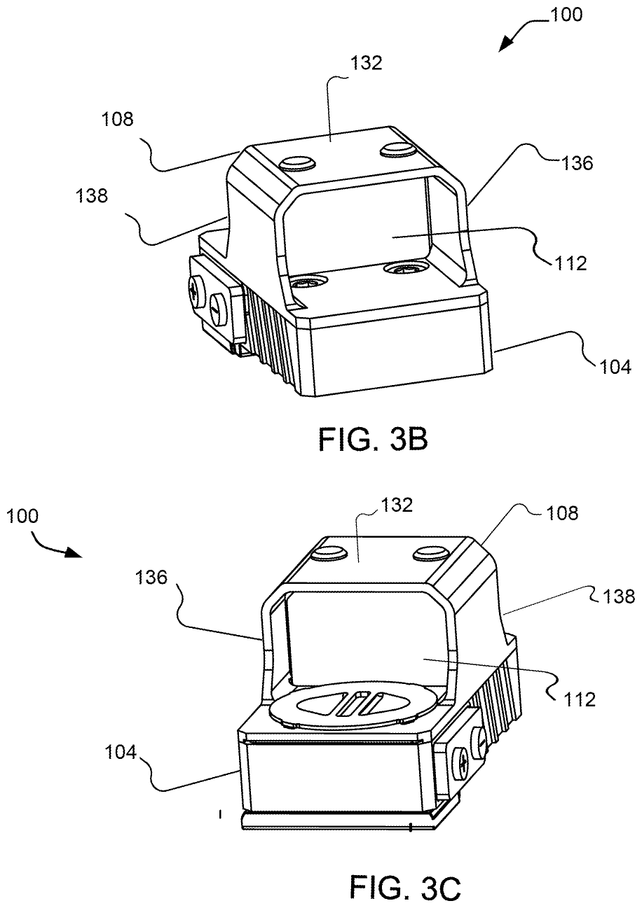

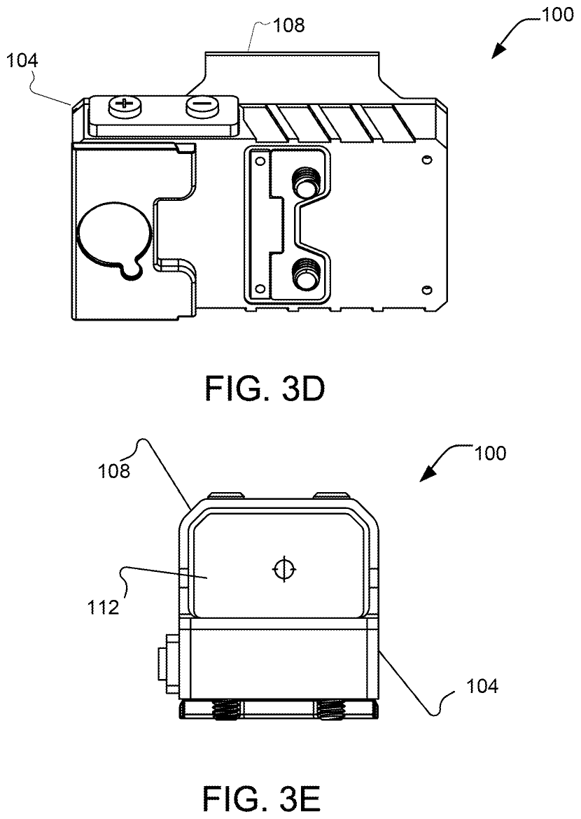

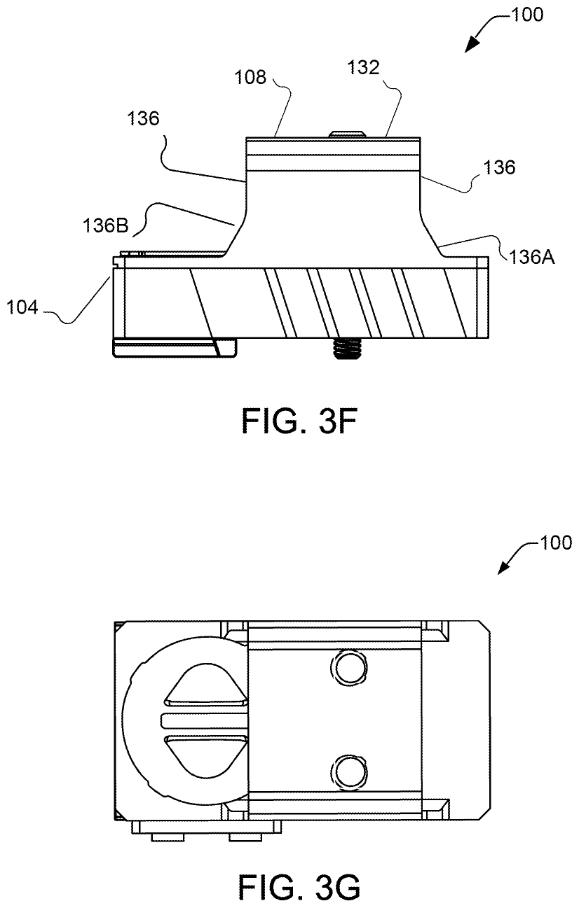

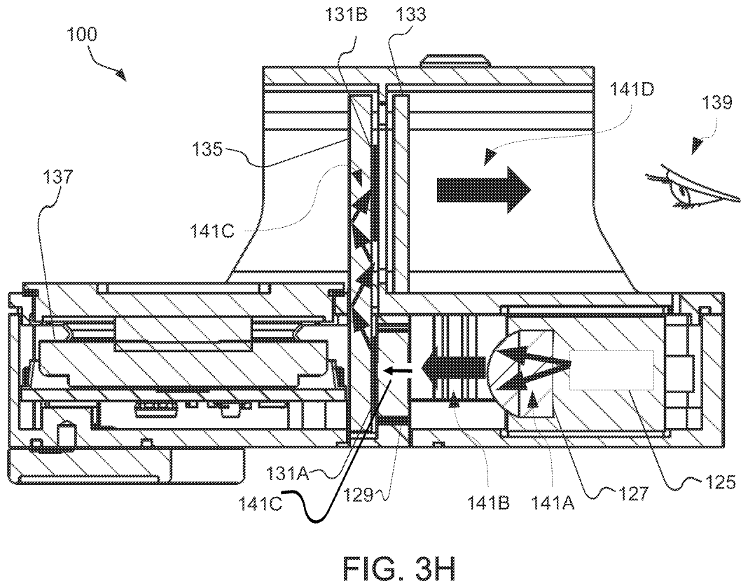

At a high level, the optical components of the sight include a light source and an imageguide optical combiner. A pattern producing element may also be included. An on-axis holographic sight 100 is shown in FIGS. 3A-3H. In FIG. 3A, sight 100 is shown attached to a portion 90 of a gun. Sight 100 has a base 104, a light shield frame 108, and a substantially transparent imageguide image combiner window 112. The on-axis sight can be used alone or in conjunction with additional optical devices and systems such as a rifle scope or other commonly used targeting optics or mechanisms such as iron sights.

Base 104 is sized and configured to engage with an instrument at a mounting location and house the operating components of sight 100, as well as to support light shield frame 108 and substantially transparent imageguide image combiner window 112. Engagement of sight 100 with a firearm may be accomplished in a variety of ways, including, for example, via screws or a quick release assembly (not shown) configured to engage the slide or barrel of a pistol or the rail of the firearm. Alternatively, base 104 may be integrated with a firearm or secured using fasteners to the firearm. Base 104 may allow the iron sights of a weapon to be used independently or in concert with the sight.

Turning to FIGS. 3B-3H, sight 100 houses an imageguide display system (discussed in more detail below), and which includes, among other things, a power supply 137, a light source 120, and controlling circuitry, which may receive user and/or sensor inputs. In an embodiment, base 104 and light shield frame 108 are substantially impenetrable by dust, debris, and water so as to prevent the components and the light pathways contained therein from being negatively impacted by those elements. In another embodiment, when power supply 137 is, for example, a battery, base 104 is configured to allow for replacement of the battery. Alternatively or additionally, power supply 137 may be a rechargeable power supply with a means of applying wireless charging power such as from a solar cell or a wireless charging system. Base 104 (and the other components of sight 100) are also designed and configured to withstand shock from firing the weapon and impacts from mishandling (e.g., being dropped).

Light shield frame 108 is disposed on top of base 104 and encompasses a portion of substantially transparent imageguide image combiner window 112. Light shield frame 108 includes a top portion 132 and opposing side portions, i.e., a first side portion 136 and a second side portion 138. Top portion 132 and opposing side portions 136, 138 are generally sized and configured to form a light shield that blocks a certain amount of ambient light from illuminating the image combiner window 112 during use. As such, top portion 132 and side portions 136, 138 extend outward from the front and rear faces of combiner window 112. (In this disclosure, the terms “front” or “forward” refer to the direction toward the user and “rear” or “rearward” refers to the direction toward the target.) Optionally, and as can be seen in FIG. 3F, a rear side portion 136A and a front second side portion 136B are wider toward base 104 than the portions are at top portion 132, and a similar configuration is included with respect to side portion 138. This “slant” orientation provides additional support for light shield frame 108. In addition, in some embodiments the light shield may be removable or replaceable with light shields having different configurations.

Substantially transparent imageguide image combiner window 112 typically includes or provides an attachable surface for certain optical or mechanical components that do not substantially interfere with the user's view of objects through combiner window 112. Substantially transparent imageguide image combiner window 112 can be coupled to base 104 by sandwiching, with or without an air gap, by laminating or other suitable mechanism, substantially transparent imageguide image combiner window 112 between a front portion and a rear portion of light shield frame 108 (front portion and rear portion also include aspects of top portion 132 and opposing side portions 136, 138). In another embodiment, substantially transparent imageguide image combiner window 112 resides in a slot such that it is retained between light shield frame 108 and base 104. Other suitable mechanisms may be used to mechanically couple substantially transparent imageguide image combiner window 112 to light shield frame 108 and base 104.

FIG. 3H is a cutaway side view of sight 100, which houses power supply 137, a light source 125 such as a laser, an image projection system including a lens 127, a diffractive optical element (DOE) 129, and an imageguide 135, wherein an input light coupling optical element 131A such as an HOE is optically coupled to imageguide 135 and an output light coupling optical element 131B such as an HOE is optically coupled to imageguide 135. In operation, light source 125 generates beams of light 141A (depicted as arrows in FIG. 3H) directed toward lens 127 that sends lights rays 141B to DOE 129. DOE 129 converts the beams of light into image 141C and then image 141C interacts with input grating 131A and is internally reflected through imageguide 135 toward window 112 before being redirected by output grating 131B through AR window 133 as viewable image 141D toward a user's eye 139.

Sight 100 includes a display system for generating and displaying content that will be visible to the user through window 112 of sight 100. The display system included may be used to generate static images (e.g., reticles or red dot) or dynamic information such as moving graphics, dynamic images, and video.

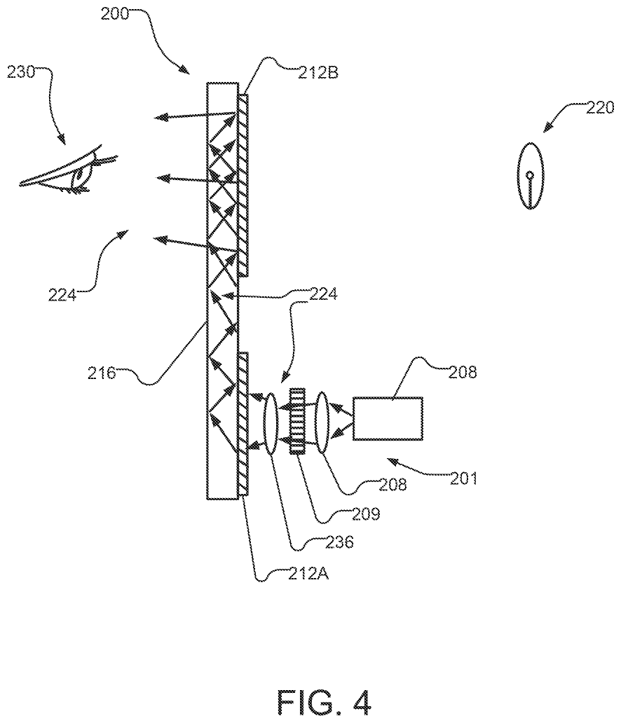

An imageguide display system, such as image guide display system 200 shown schematically in FIG. 4, is housed within sight 100 and allows sight 100 to provide additional information, such as the image of a targeting reticle, to the user that is overlaid, in a substantially see-through fashion, upon the image of the real world visible through window 112 and targets that are viewable through the sight. In an embodiment, imageguide display system 200 can include a display projection system 201 that includes a light engine 204 containing individually or in combination a source of light such as a laser or LED, an array of lasers or LEDs, an organic LED (OLED) array, a micro-LED array, and may include a pattern generating element such as an LCD panel, a micromirror array, a shadow mask 232 or a diffractive optical element (DOE), as well light shaping optical elements or projection optics 336. (It will be understood that a number of suitable light coupling optical elements may be used with the image guide display system, but for clarity the embodiments described herein will generally refer to HOEs and DOEs.) In an embodiment, imageguide display system 200 produces an image that is optically relayed to the user 230 through diffraction grating holographic optical elements including an input HOE 212A, a total internal reflection imageguide 216 and an output HOE 212B that together combine to produce a virtual image of an illuminated display 220 for viewing by the user 230 (i.e., the user's eye) looking into sight 100. Diffraction grating holographic optical elements HOEs 212A and 212B may function in either reflection or transmission modes and as such may be placed on either side of a total internal reflection imageguide 216 so long as HOEs 212A and 212B are located in the optical path formed by light engine 204, projection optics 206, imageguide 216, and the user 230.

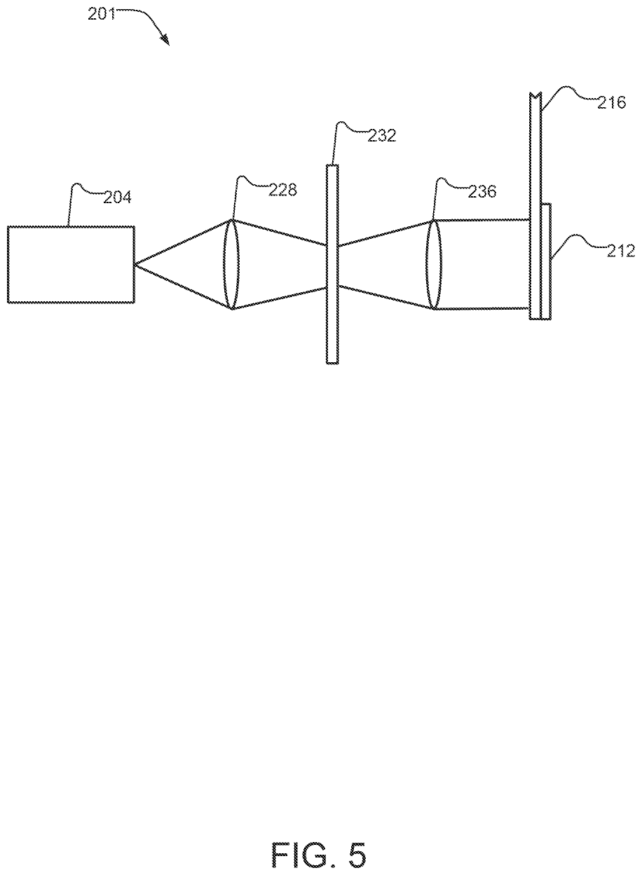

In one embodiment, display projection system 201 (shown schematically in FIG. 5 apart from imageguide display system 200) consists of a light source 204, condenser lens 228, shadow mask 232, projection lens 236, that together with imageguide 216 and diffraction grating holographic optical elements HOEs 212A and 212B combine to provide to user 230 virtual image of an illuminated display 220 (such as shown in FIG. 4) for viewing by the user. As shown in FIG. 4, imageguide display system 300 produces viewable information 224, e.g., an illuminated reticle pattern, that is received by lens 236, then directed to input HOE 212A for propagation via total internal reflection through imageguide 216 to output HOE 212B, which directs information 224 to user 230 in the form of a virtual image of an illuminated display 220. In an embodiment, imageguide display system 200 typically attenuates less than 10% of the broadband ambient visible light entering sight 100 (notable when comparing display system 200 with, for example, beam splitting technologies that inherently attenuate 30% to 60% of the incoming light, which makes targets more difficult to detect and identify and limits the use of that type of scope in low-light conditions). The broadband light throughput performance of the imageguide display system 200 is also superior in that regard compared to a reflective or reflex sight system that uses a wavelength specific reflective coating that blocks parts of the optical band that would otherwise be visible to the user.

In one embodiment, diffraction grating holographic optical elements HOE 212A and HOE 212B are on the same side of the total internal reflection imageguide 216 and may be one continuous diffraction grating structure or separate grating structures (as shown in FIG. 4). In one embodiment, display projection system 201 is located on the side of a total internal reflection imageguide 216 opposite to that of user 230 such that the optical path formed by display projection system 201 and imageguide 216 have an optical axis parallel to the optical path from user 230 to the virtual image of an illuminated display 220 appearing at the aim point located at a distance from the user. In that instance, the image location is independent of the slant angle of imageguide 216 relative to that axis in a manner similar to a two mirror periscope. As such, an angular adjustment of the optical axis of display projection system 201 relative to an optical path from user 230 to the target will result in a change in the relative location of the image produced by display projection system 200 and can facilitate accurate aiming of the firearm by “zeroing” the sight to an aim point at specific distances and making adjustments in elevation and windage to improve accuracy.

In one embodiment, the display projection system is located on the same side of the internal reflection imageguide as the user such that the optical path formed by the display projection system and the imageguide still have an optical axis parallel to the optical path from the user 20 to the virtual image of the illuminated display but an angular adjustment of the optical axis of display projection system relative to an optical path from the user to the target will result in a change in the relative location of the image produced by the display projection system by a factor of two over the opposite side orientation previously discussed. In one embodiment, the angular adjustment is performed by translating the lens relative to the axis of the illumination while other components of the display projection system are fixed in their locations, which allows for zeroing the sight.

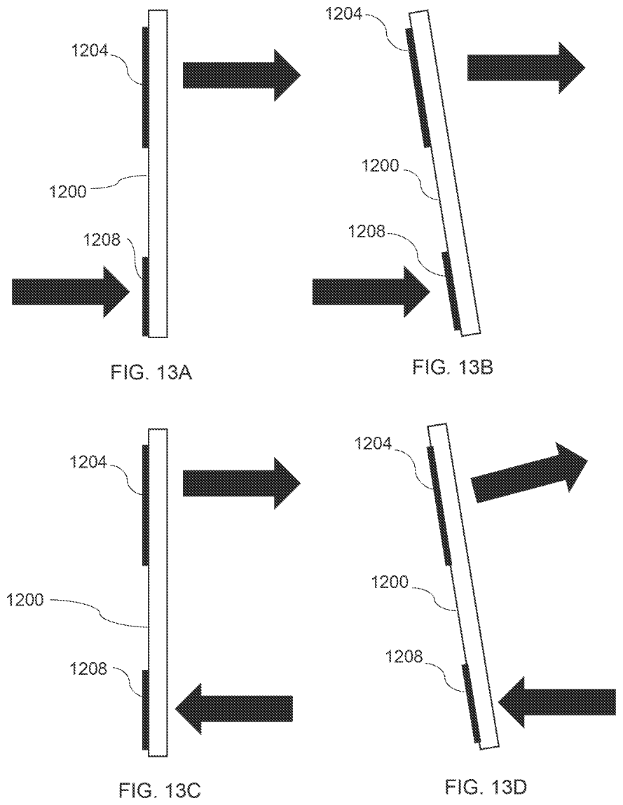

This dependence on the relative locations of the light source and viewer of the effect of angular displacement of the image relative to the optical path and the incident angle to the imageguide is demonstrated schematically in FIGS. 13A-13D. IN each of FIGS. 13A-13D, an imageguide 1200 includes an input light coupling element 1204 and an output light coupling element 1208. In FIGS. 13A and 13B, the light (depicted by an arrow) enters on a first side of imageguide 1200 and exits on the opposite side for the viewer. As shown in FIG. 13B, in this configuration, the exiting light direction is parallel with the entering light direction even when imageguide 1200 is not perpendicular to the incoming light. However, as can be seen in FIGS. 13C-13D, the exiting light direction is not parallel with the entering light direction when imageguide 1200 is not perpendicular to the incoming light (as in FIG. 13D).

Lenses 228 and 236 are sized and configured to transmit the display information from light engine 204 to input HOE 212A such that the display information can be transmitted through imageguide 216. Since holographic optical elements can function in several modes including reflection and transmission, the implementation of image coupling into or out of the imageguide has a multiplicity of possible combinations of the locations on the imageguide of the HOE's. Diffraction gratings HOE 212A and 212B may also have the optical functions of lenses or mirrors, thus eliminating the need for the some of the other optic(s) in the display system or projection system. Positioning an additional HOE, or combinations of HOE's, at specific locations on the imageguide can provide additional optical functions such as magnification, pupil expansion or distortion correction.

HOEs 212 are substantially transparent diffraction gratings that are designed and configured to steer displayable information 224 into and out of imageguide 216. In an embodiment, HOEs 212A and 212B are capable of directing displayable information 224 into and out of imageguide 216, which relays the image using total internal reflections. As shown in FIG. 4, HOE 212A directs displayable information 224 received from light engine 204 so as to guide the display information through imageguide 216 using total internal reflection toward HOE 212B. HOE 212B directs the display information to the user to be viewed when looking through the sight. HOE 212B may act in reflection mode if located on the side of the imageguide away from the user as shown in FIG. 4, or act in transmission mode if placed on the side closest to the user. Other methods and optical structures could be used to accomplish the same functions of coupling light or images into and out of the imageguide, such as a prism, microprism array, an angled mirror or micromirror array, etc.

A wide range of materials and methods of producing the HOEs such as HOEs 212A, 212B and 212C may be used to produce the diffracting structures on the surface or internal to the imageguide, such as a photopolymer layer and laser exposure, a polymer layer and nanoimprint pattern transfer into it, optical metastructures microfabricated on the surface or internal to the imageguide, electron beam lithography of a master mask with subsequent contact printing, micro- and nano-lithography, embossing, etching or laser ablation and other methods known to those skilled in the art. These diffracting structures may act to couple light into and out of the imageguide or modulate its propagation in reflection or transmission modes or in any combinations of modes. Incorporating electrooptical materials, such as liquid crystals, can provide for the incorporation of electrically addressed functions or a modulation of the light propagation when interacting with the diffracting structures. Other methods and optical structures known to those skilled in the art could be used to accomplish the same functions of coupling light or images into and out of the imageguide such as a prism, microprism array, angled mirrors, partially transparent angled mirror or micromirror arrays, etc.

Imageguide 216 is a substantially transparent plate that propagates wavelengths substantially internally. Imageguide 216 can be many different shapes, including, but not limited, to rectangular, trapezoidal, oval and circular as well as with flat or curved configurations. Imageguide 216 can be produced of a broad range of substantially transparent materials including glasses, plastics, or hybrid materials.

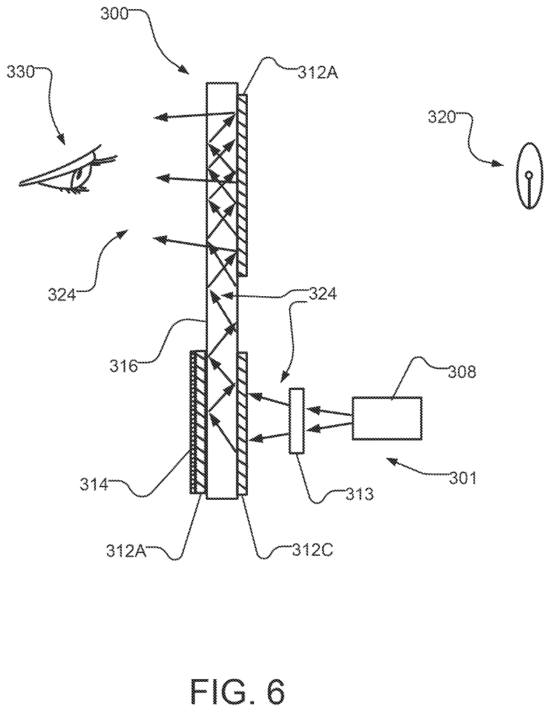

In another embodiment (as shown in FIG. 6), an image guide display system 300 is similar to imageguide display system 300 but includes a reflective holographic optical element HOE 312C placed on the side of the imageguide opposite the display projection system 301 so that HOE 412C intercepts and diffracts the incoming light in reflection mode with or without HOE 412A. A reflective coating 314, such as aluminum or a mirror, is disposed on the HOE, surrounding HOE 312A or just on the side of the HOE opposite light engine 304. The addition of coating 314 improves the light throughput into the imageguide 316. In an embodiment, the inclusion of coating 314 improves overall light throughput (input to output transmission as a ratio of the incoming light to exiting light) by up to 40%.

In an embodiment, the imageguide display systems can include a sensor or camera (not shown) to track the user's eye movements and eye orientation. In certain embodiments, illumination, such as infrared light, can also be provided at the eye location so as to assist with the analysis of the orientation of the eyeball (infrared light can be used to generate and track an image of the user's eye by sending infrared light down it which is not visible to the user). The light, which can be a point source or a broad source, illuminates the user's iris, cornea and retina. This light is then sent through the imageguide where a camera or sensor captures aspects of the image or reflected light and then is processed to derive information about the user's eye. In this way, the same imageguide that is used to display a reticle or other image to the user can simultaneously gather information from the user's eye for acquiring and tracking useful data such as the user's direction of gaze, eye movements, focus distance, heartrate and unique personally identifying biometric information which can authenticate the user for safety or security purposes. Additionally, a camera equipped imageguide approach can simultaneously be used to capture an image or video of the user's visual area of regard and their target for recording and later playback showing and confirming what the user saw when engaging the target.

In an embodiment the light engine in the display projection system can be configured to produce a full color, sunlight legible, high resolution image for transmission to a user of the sight. The image produced by the display projection systems can be read against the brightest scenery (e.g., a sunlit cloud in the sky), while still dimming enough to be compatible with night time use and use in conjunction with night vision goggles. Beam splitting prisms systems cannot handle combining the real-world scene with a full color image display without significant attenuation and because of that limitation cannot produce images with the desired clarity/readability in bright light (sunlight) without also attenuating the scene. The display projection systems may be configured with a light engine and a suitable source of imagery such as a transmissive liquid crystal display panel, liquid crystal on silicon display chip (LCOS panel), micromirror display chip, laser scanning projector or MEMS device, LED or micro-LED array, organic LED array, laser array, digital light projector, acousto-optic modulator or spatial light modulator and can receive one or more image and data inputs, which can include, but are not limited to digital or analog data, a still or moving image, computer generated graphics, video derived images, a sensor derived direction, elevation, and/or a cant, or one or more sensor inputs (such as, but not limited to, temperature, pressure, humidity, wind speed, and light) and display that to the user through the imageguide display system. Sensor inputs such as from a camera that images in visible light, near infrared (NIR), shortwave infrared (SWIR) or thermal wavelengths can also be applied to a suitable display projection system with associated light sources and optical elements. Digital information or information derived from an analog sensor can also be displayed in the on-axis holographic sight text or graphical messages, target derived data such as range to target, as well as ballistic information such as bullet fly-out and trajectory, a disturbed reticle with an ideal placement of the aimpoint on the target, ballistic solution for bullet drop or computed leading of the target based on its movement or weapon derived information such as numbers of rounds remaining or expended in the weapon's magazine, weapon cant angle, and to support enhanced situational awareness and provide an augmented reality overlay. AI interfaces can also be utilized to analyze a potential target to determine its threat level and display this information on the display in order to assist the shooter in prioritizing engagement with multiple potential targets which is highly useful in both training and tactical applications of the system In training applications, additional information can be displayed such as synthetic or simulated targets, performance scores or the replay of sensor derived information such as from a camera used to record the target or a down range view.

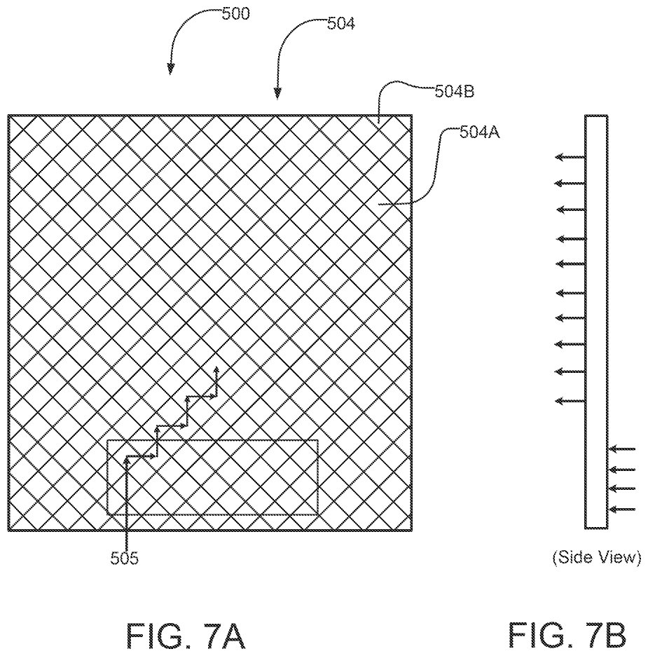

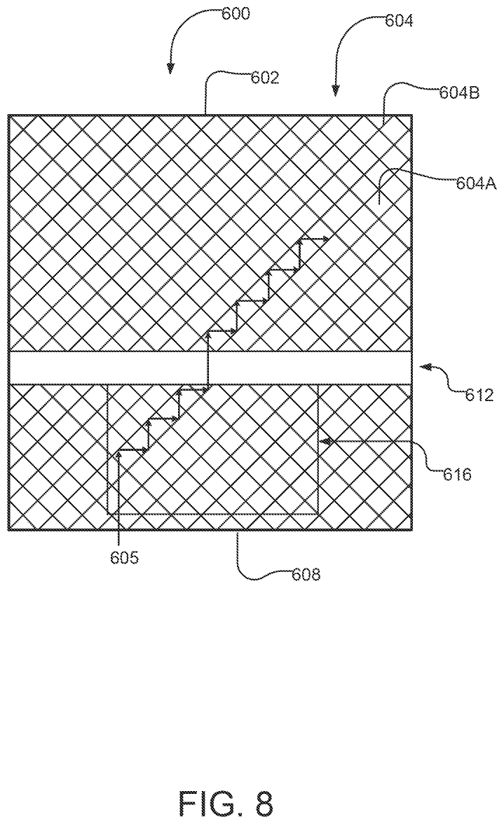

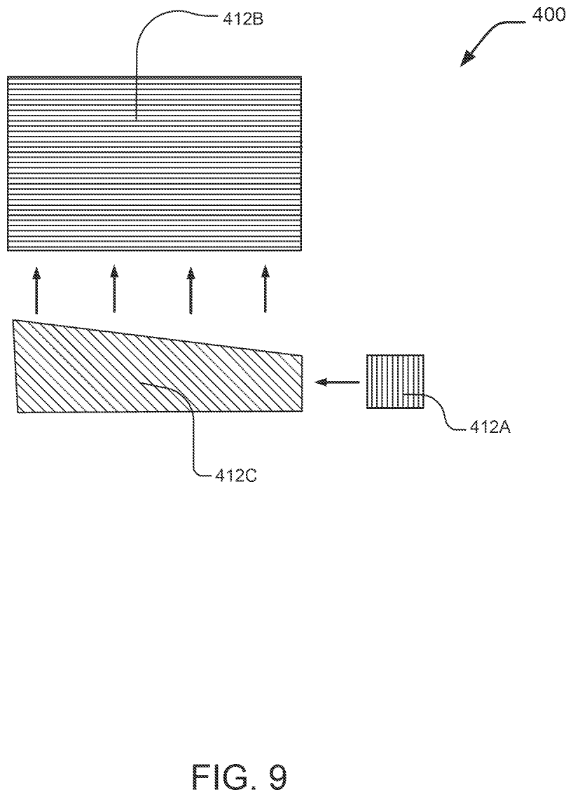

Creating a useful “eyebox” that is larger than the user's pupil with a large field of view can benefit from a grating and imageguide geometry that provides “pupil expansion” owing to the user observing a multiplicity of overlapping images of the display information. This can be accomplished in a number of ways. For example, a single axis expansion can be accomplished using plane gratings that only multiply the image of display information in the axis perpendicular to the grating vector such that the user can see the entire image in an increased eyebox in that one axis. In a corresponding approach to providing an increased eyebox in two dimensions, a combination of gratings or a suitably designed grating structure or imageguide geometry can create expansion in two axes. Two axis expansion offers a larger eyebox and improves the user's field of view. Two axis expansion can be accomplished with a number of grating combinations, such as the overlap of plane gratings at angles to each other as shown in FIGS. 7A-7B and 8 or a three grating approach that is shown in FIG. 9, discussed in more detail below. Adjusting the diffraction efficiency of the gratings along the axis of their interaction with the propagating image can make the image intensity more uniform, or to adjust the color uniformity in a multicolor

In this latter approach, as shown for example in FIG. 9, a first (input) grating 412A directs the incoming image along an axis to a second (turning) grating 412C with a grating vector at a 45 degree angle to the first axis which then directs the image to the a third (output) grating 412B which has an axis at an angle of 90 degrees from the first grating. In an embodiment, gratings 412 are prepared using laser beam interference techniques with a photoresist material. For example, two coherent ultraviolet laser beams with wavelength λ may be directed at an included angle θ at a substrate coated with photoresist so as to produce a diffraction grating pattern of lines with a sinusoidal cross section, with the periodicity of the grating being approximately λ/sin θ. This pattern in resist may further be transferred using etching directly into the substrate or to pattern a hard mask with a subsequent etch step or followed by ion milling to produce a binary grating with straight or slanted walls or a blazed profile. The gratings and HOE's required for this approach may be accomplished by any suitable production technique.

FIG. 7A is a schematic illustration of an embodiment of a single diffraction grating HOE with dual-axis expansion (DAE) 500, according to an embodiment of the present disclosure. DAE 500 has two overlapping linear grating structures, a set of right slant grating lines 504A and a set of left slant grating lines 504B running in a “cross” pattern to each other. The resultant microstructure may then consist of an array of either depressions or bumps with a periodicity determined by the spacing of the grating periods. As shown in FIG. 7A, sets of slant grating lines 504A and 504B run at 45 degrees and are perpendicular to each other, but can be at other angles to each other and relative to the optical axis of the imageguide to produce varied fields of view and eyebox extents for the user. By virtue of the design of DAE 500, there is a third “virtual grating” produced by the pitch of the intersections of the gratings at the tangent of the angle between 504A and 504B, which serves to couple light into and out of the imageguide. This action is performed in transmission mode for light coming into the grating or in reflection mode if a mirror or reflective coating is applied behind at least a portion of the DAE 500, as well as enabling the outcoupling of the image light in the HOE (e.g., HOE 212B or HOE 312B). In this way, a single diffraction grating covering the distance from the optical input to the image output serves to expand the image in two dimensions. For example, light ray 505 transmitted to DAE 500 is reflected upon impacting a first ruling 504A, which changes the direction of a portion of light ray 508 (expanding) and returns a portion of the light ray toward the user's eye (as illustrated in the “Side View” of FIG. 7B). This redirection and returning continues throughout the DAE 500. In an embodiment, the gratings are configured such that less light is transmitted out to the user's eye closer to the input of the light ray so as to create a more uniform light intensity image as shown schematically in the sideview by the lengths of the lines. In an embodiment, multiple imageguides, each with associated input and output gratings, can be located in a series configuration such that optimization of performance with multiple colors and color uniformity may be achieved by stacking layers of individual imageguide structures with an alignment of the input and output regions. In such an instance the user will see the combination of each layer's image superimposed in a single multicolor image.

FIG. 8 is a schematic illustration of another embodiment of a single diffraction grating with dual-axis expansion (DAE), DAE 600, according to an embodiment of the present disclosure. DAE 600 has a first portion 602 with two overlapping rulings, a set of right slant rulings 604A and a set of left slant rulings 604B running in a “cross” pattern (as shown 604A and 604B run at 45 degrees and are perpendicular to each other, but can be other grating angles). DAE 600 also includes a second portion 608, which is separated from first portion 602 by an unruled portion 612. Second portion 608 acts as an output grating and can include a “cross” pattern or any other ruling pattern such that light 605 is transmitted toward first portion 602. The inclusion of unruled portion 612 improves the quality of light emanated from first portion 602 (when compared against a DAE without an unruled portion such as DAE 500) because less light is lost in the lower area of DAE 600. The resultant microstructures in either area may then consist of an array of either depressions or bumps with a periodicity determined by the spacing of the grating periods. In certain embodiments, a coating 616 is applied behind second portion 608 to improve light transmission. In certain embodiments, first portion 602 is configured with a single axis grating such as a grating ruled perpendicular to the light propagation direction which can be a volume grating, a blazed structure or have slanted grating elements for higher optical throughput efficiency. The design and fabrication of the grating structures may provide a gradient in their diffraction efficiency in order to compensate for the illumination drop resulting from the extraction of light at each interaction between the image light and the gratings. In such an instance the grating's outcoupling efficiency would be less at the input and increase along its extent.

FIG. 9 is a schematic of a three grating pupil expanding imageguide system 400, such as used in imageguide display system 200 shown in FIG. 4, that includes an input grating 412A, a turning grating 412C, and an output grating 412B. The pupil expansion is accomplished along a single axis in the process of the image traversing the imageguide and interacting with the three gratings individually. In the orientation shown in FIG. 9, grating 412C provides horizontal expansion of the pupil and grating 412B provides vertical expansion of the pupil and in combination the two gratings increase the size of the eyebox in both axes.

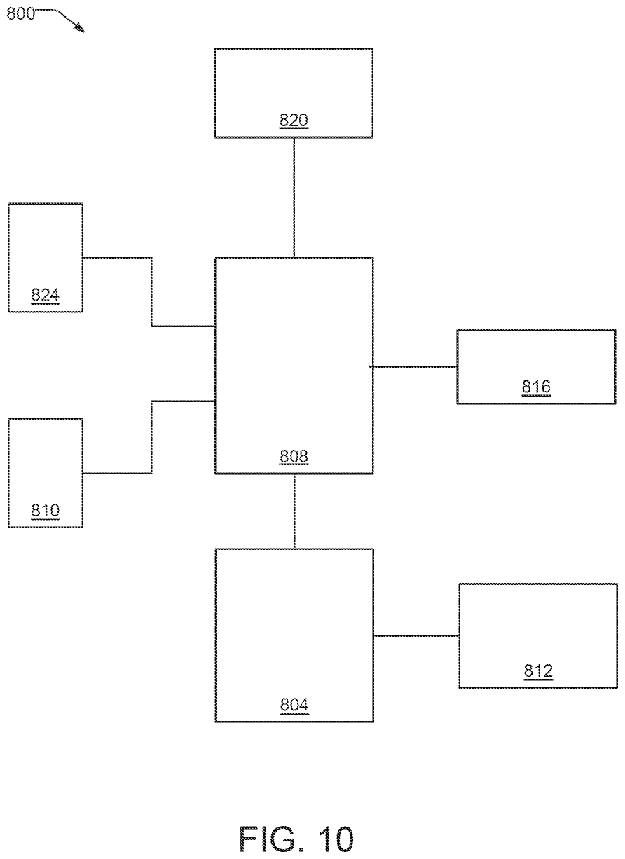

Turning now to FIG. 10, which is a schematic diagram of components 800 of another sight. In this embodiment, sight 800, in addition to having the holographic display (similar to sights 100 and 200), include a plurality of sensors. Sight 800 includes a light source 804 (e.g., laser diode), a controller 808, a power supply 812 (e.g., battery), a motion sensor 816, a first light sensor 820, and a second light sensor 824. These components work together to modulate the reticle illumination for the ambient light conditions and to turn/off the hologram so as to conserve battery life. For example, controller 808 can receive a signal from motion sensor 816 of movement of an instrument to which sight 800 is attached thus activating sight 800. Similarly, controller 808 can monitor signals from motion sensor 816 to determine a period of inactivity, at which point sight 800 may turn off.

First light sensor 820, positioned in the front of sight 800 and directed toward the target, monitors the light reflected from the target and provides a signal representative of the its brightness to controller 808. Second light sensor 824 monitors the ambient light proximate sight 800. In combination, first light sensor 820 and second light sensor 824 can cooperate to provide the appropriate output light for the reticle. For example, if both light sensors indicate a relatively dark environment, the strength of the reticle light will be relatively low so as to not interfere with viewing the target. If, however, the ambient light around the sight is dark/low (indicating that the reticle light should be low), but the light around the target is bright/high, controller 808 can adjust the strength of the projected reticle light such that the hologram is still viewable on the target.

In addition to the functions described earlier, sights 100, 200, and 500 can include on/off, reticle shape toggling when used in conjunction with a switchable reticle generator (circle, cross-hairs, etc.), auto-brightness, and auto-off. An eye-tracking system 830, which may be composed of a light source and a camera or a sensor array for visible or invisible light, and configured to communicate with the controller 808 information derived from sensing the eye.

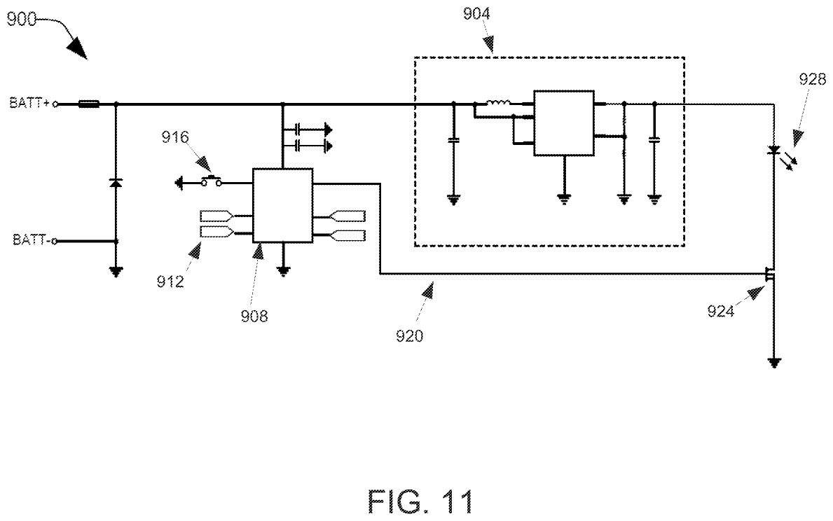

Turning to FIG. 11, an embodiment of a control circuit 900 for light control of a light source is shown. A three (3) level brightness design is shown, although it may be programmed to have as many levels of brightness as desired. Other microcontrollers or circuit design approaches could be used. A boost circuit 904 ensures a constant voltage at the LED regardless of input voltage as the battery discharges, which allows a consistent brightness on the LED to be maintained. The microcontroller produces a PWM signal that controls the brightness on the LED. Because the output of the boost circuit is designed to be at the threshold of the LED, a current limiting resistor need not be used. The microcontroller debounces the input from the Brightness Select Switch. Based upon the number of presses of the switch, a pre-programmed brightness on the LED is selected. This brightness is converted to a PWM signal. Brightness options, may be, for example, OFF, Low, Medium, and Full ON. Control circuit 900 includes a control switch 916, a control circuit 908, a plurality of inputs 912, an output line 920 connected to a control device 924. Circuit 908 is also operably connected to light source 928.

An imageguide combiner for an on-axis sight with a laser/DOE or LED/reticle and having a laser, a lens, and a DOE (such as is depicted in FIG. 4) may also include a second lens between the laser and the DOE. In order to have the largest eyebox, it is advantageous to have a large input pupil. Having a correctly filled DOE with redundant pattern elements is also advantageous to reduce image graininess and keep the images crisp and uniformly bright. DOE performs well with a highly uniform beam with radially symmetric divergence; however a non-radially symmetric beam can be used with suitable shape correction in the DOE. In order to accomplish this using refractive optics, a relatively small diameter laser beam may be expanded using a two lens system. In this instance, the toroidal nature of the second lens is used to create radial symmetry in the divergence. Both lenses can be aspherical for the purposes of beam quality, but the DOE can provide a reasonable amount of correction for lower quality optics or to replace the lens(es) entirely. Other methods of providing collimation and beam shaping can be applied to these functions of the reticle illumination such as reflective surfaces or additional diffractive or refractive elements

The imageguide combiner includes an imageguide, which provides lateral displacement of an infinitely conjugate image, an output grating, which provides lateral expansion for an eyebox/output pupil larger than the input pupil and couples light out of imageguide, an input grating, which is the input pupil that couples light into imageguide, and a diffractive optical element (DOE), which imparts an arbitrary image pattern into the beam. DOE is also capable of providing optical power to the illumination and corrective power or magnification of the image. Because DOE 1016 is more efficient than a reticle that shapes and image, it is more power efficient. The element may be made as a binary DOE or with multiple levels or as a kinoform or holographic optical element and can be made a variety of ways including etched, coated or embossed into/onto glass or suitable plastic substrates. A movable element with a number of reticle DOE patterns would provide the user a way to change the image mechanically. An electrically switchable version of the reticle DOE, such as a switchable optical element, could provide a number of different patterns chosen by the user with an electrical input.

In addition, the system may include a toroidal lens, which is a lens designed and configured to collimate light from a laser into a uniform beam with radially symmetric divergence, a focusing lens, which is a fast lens that focuses the light from the laser in order to allow for expansion, and a laser diode or other suitable light source, which is a high beam quality red or green laser. In some configurations more than one color light source could be utilized for specific applications, i.e., a red laser to make an aiming reticle pattern and a green laser for assisting the user in finding the aiming reticle with arrows pointing to the center of the sight's FOV. Multiple colors could be assigned for other functions and attached to sensors such as friend or foe indicators, indicate the thermal center of mass, or provide more realistic images where color is important for the user's task and situational awareness.

For an on-axis holographic sight system that uses an LED, mask, and a lens element as depicted in FIGS. 4, it may be advantageous to have a large input pupil in order to have the largest eyebox and highest throughput efficiency. To this end, the LED is mounted directly against the mask or even coupled to the mask 209 with an index matching adhesive, foregoing lens 208, however a small air space is acceptable to allow for multiple images to be present on a movable mask. The smallest possible LED die may be used for power conservation as the vast majority of light is rejected by the mask. For maximum brightness, the highest numerical aperture lens that can be well corrected should be used to image the plane of the mask to infinity. The lens can be a singlet lens, a compound lens or a lens system with multiple light shaping elements as required. The lens element can be diffractive, holographic, or have a nanostructured metasurface, preferably using an economical design and fabrication process. In addition, a light source such as an LED array or OLED array may produce a pattern itself.

Another on-axis imageguide system includes an imageguide that provides lateral displacement of an infinitely conjugate image, an output grating, which provides lateral expansion for an eyebox/output pupil larger than the input pupil and couples light out of the imageguide, an input grating, which is the input pupil that couples light into the imageguide, and an achromatic asphere, which is a high numerical aperture lens that collimates the LED light into a well spherically and chromatically corrected beam. In addition, a mask is a thin opaque part with an aperture corresponding to an arbitrary image, and an LED 1224 is a bare die LED with high brightness.

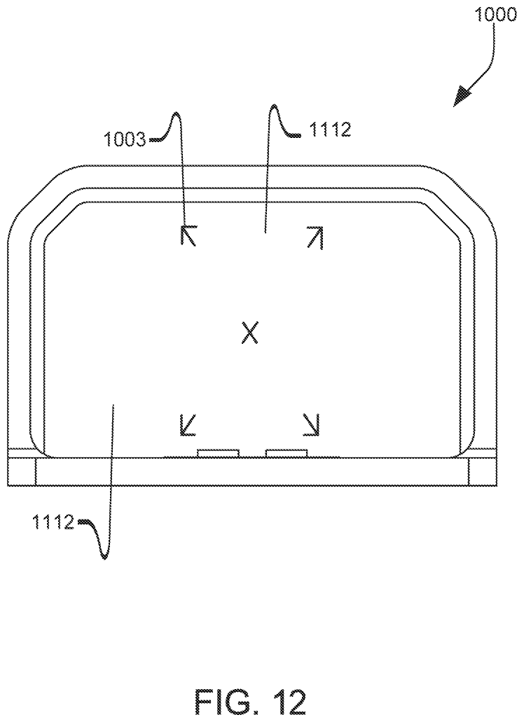

Turning now to FIG. 12, a view through an on-axis sight 1000 showing a virtual image 1003 displayed through a combiner window 1112 generated by an image projection system of on-axis sight 1000 in which it can be seen that much of the real-world scene 1001 as viewed through the sight is not attenuated or distorted.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An on-axis holographic sight comprising:
a base configured to engage a mounting location on an instrument, wherein the base includes an image projection system, the image projection system including a power supply, a light source, and a controlling circuitry;
a light shield frame attached to the base;
a substantially transparent imageguide image combiner window contained within the frame; and
an imageguide display system optically coupled to the image combiner window, the imageguide display system including a light source, an image generating element, a light coupling optical element, and an imageguide element, wherein the light source is configured to direct light to the image generating element, wherein the image generating element is configured to project image information to the light coupling optical element, wherein the light coupling optical element is configured to transmit the image information into the imageguide element, and wherein the imageguide element is configured to direct the image information through the image combiner window such that a virtual image based on the image information is viewable by a user viewing a real-world scene through the image combiner window when the sight is attached to the instrument.

2. The on-axis holographic sight of claim 1, further including an eye-tracking system, wherein the eye-tracking system is in communication with the controlling circuitry.

3. The on-axis holographic sight of claim 1, wherein the sight is connected to a plurality of sensors, and wherein the plurality of sensors includes a motion sensor, a first light sensor, and a second light sensor.

4. The on-axis holographic sight of claim 3, wherein the image information is modulated based on light conditions determined by the first light sensor and the second light sensor.

5. The on-axis holographic sight of claim 4, wherein the imageguide display system is activated based on movement of the instrument detected by the motion sensor.

6. The on-axis holographic sight of claim 1, wherein the image generating element is a shadow mask.

7. The on-axis holographic sight of claim 1, wherein the image generating element is a diffractive optical element.

8. The on-axis holographic sight of claim 1, wherein the light source is a laser.

9. The on-axis holographic sight of claim 8, wherein the light coupling optical element is a holographic optical element or a diffractive optical element.

10. The on-axis holographic sight of claim 1, further including a lens between the light source and the light coupling optical element.

11. The on-axis holographic sight of claim 1, wherein the light coupling optical element is an input optical element optically coupled to the imageguide element and wherein an output optical element is optically coupled to the imageguide element.

12. The on-axis holographic sight of claim 1, wherein the image information is relayed from the image generating element to the image combiner window through a plurality of diffraction grating optical elements and total internal reflection in the imageguide element without passing through air.

13. The on-axis holographic sight of claim 12, wherein the image information is transmitted to the user from the image combiner window without a concave mirror.

14. The on-axis holographic sight of claim 1, wherein the image information includes a reticle pattern.

15. The on-axis holographic sight of claim 1, wherein the light source is on a side of the imageguide element opposite to that of a user of the instrument viewing the image combiner window.

16. The on-axis holographic sight of claim 1, wherein the light source is on a side of the imageguide element that is the same as that of a user of the instrument viewing the image combiner window.

17. The on-axis holographic sight of claim 1, wherein the combiner window attenuates less than 10% of broadband ambient visible light striking the combiner window.

18. The on-axis holographic sight of claim 12, wherein one of the plurality of holographic optical elements includes a reflective coating on a side opposite from the light engine.

19. The on-axis holographic sight of claim 12, wherein the plurality of diffraction grating holographic optical elements multiply the image information in an axis perpendicular to a grating vector such that the user can see all of the virtual image in an increased eyebox in that axis.

20. The on-axis holographic sight of claim 12, wherein the plurality of diffraction grating optical elements and imageguide element together multiply the image information along two axes such that a user can see the image information in an increased eyebox in those axes.

21. The on-axis holographic sight of claim 20, wherein at least one of the plurality of diffraction grating optical elements has an outcoupling efficiency that varies in an axis of propagation of the image information such that a brightness of the virtual information is made uniform in the eyebox.

22. The on-axis holographic sight of claim 1, wherein the imageguide display system further includes a diffraction grating holographic optical element with dual-axis expansion, the diffraction grating holographic optical element including two overlapping linear grating structures, the overlapping linear grating structures including a plurality of right slant grating lines and a plurality of left slant grating lines, wherein the plurality of right slant grating lines and the plurality of left slant grating lines form a pattern of holes or posts that are a superposition of the plurality of right slant grating lines and the plurality of left slant grating lines.

23. The on-axis holographic sight of claim 22, wherein the plurality of right slant grating lines and the plurality of left slant grating lines run at 45 degrees and are perpendicular to each other.

24. The on-axis holographic sight of claim 1, wherein the imageguide display system further includes a diffraction grating holographic optical element, the diffraction grating holographic optical element including a first portion and a second portion, wherein the first portion and the second portion include a diffracting structure that is equivalent to the superposition of a plurality of right slant rulings and a plurality of left slant rulings, wherein the plurality of right slant rulings and the plurality of left slant rulings run in a pattern of holes or posts, and wherein the diffraction grating holographic optical element includes a third portion separating the first portion from the second portion, wherein the third portion is unruled.

25. The on-axis holographic sight of claim 1, wherein the imageguide display system further includes an achromatic aspheric lens configured to collimate light from the light source into a well spherically and chromatically corrected beam.

26. The on-axis holographic sight of claim 8, wherein the imageguide display system further includes a toroidal lens configured to collimate light from the laser into a uniform beam with radially symmetric divergence.

27. (canceled)

28. (canceled)

29. (canceled)

30. (canceled)

31. The on-axis holographic sight of claim 1, wherein the virtual image appears at a distance from the instrument when viewed by the user through the image combiner window.

32. A method for assisting with optical aiming of an instrument comprising:
attaching a base to the instrument, the base including a substantially transparent display window optically coupled to an image display system;
producing a light from a light source within the base;
generating image information by passing the light through an image generating element within the base;
directing the image to an input light coupling optical element that transmits the image information into an internally reflecting imageguide; and
displaying a virtual image based on the image information through the display window such that the virtual image is viewable to a user of the instrument,
wherein the virtual image is viewable to a user of the instrument and appears to the user to be at a distance from the instrument.

33. A sighting device comprising:
a housing configured to engage with an instrument;
a light source in the housing;
an image generating element in the housing configured to receive light from the light source;
an input light coupling optical element in the housing configured to receive image information from the image generating element;
an imageguide optically coupled to the input light coupling optical element, wherein the input light coupling optical element is configured to direct the image information into the imageguide; and
an output light coupling optical element optically coupled to the imageguide, wherein the output light coupling optical element is configured to receive the image information from the imageguide and project light out of the housing such that a virtual image based on the image information is viewable to a user of the instrument and appears to the user to be at a distance from the instrument.

34. The sighting device of claim 33, wherein the image information is transmitted from the output light coupling optical element to the user without a concave mirror.

35. (canceled)
